(19) United States
(12) Patent Application Publication
(10) Pub. No.: US 2012/0117601 A1
(43) Pub. Date: May 10, 2012

(54) USER INTERFACE FOR AUDIO VIDEO DISPLAY DEVICE SUCH AS TV

(75) Inventors: Sabrina Tai-Chen Yeh, Laguna Beach, CA (US); Yuko Nishikawa, La Jolla, CA (US); Tracy Barnes, San Diego, CA (US); Hyehoon Yi, Escondido, CA (US); Seth Guy Hill, La Mesa, CA (US); Steven Friedlander, San Diego, CA (US)

(73) Assignee: SONY CORPORATION

(21) Appl. No.: 13/231,258

(22) Filed: Sep. 13, 2011

Related U.S. Application Data
(60) Provisional application No. 61/411,559, filed on Nov. 9, 2010.

(51) Int. Cl. H04N 21/431; H04N 5/44

(52) U.S. Cl. 725/42; 725/43; 348/734; 348/E05.096

(57) ABSTRACT

For a graphical user interface (GUI) for an audio video display device (AVDD) showing current video on a portion of the display, a bottom row of category icons is presented on at one end of the row a column of content panes representing content related to a category of a selected one of the icons.

This application claims priority from U.S. provisional patent application Ser. No. 61/411,559, filed Nov. 9, 2010.

### I. FIELD OF THE INVENTION

The present application relates generally to user interfaces (UI) for audio video display devices (AVDD) such as televisions (TVs).

### II. BACKGROUND OF THE INVENTION

Graphical user interfaces (GUI) for audio video display devices (AVDD) such as TVs have been provided for enabling viewers to browse and select video streams for play on the TV. An electronic program guide (EPG) is an example.

As understood herein, as home entertainment has evolved from watching a handful of broadcast TV channels to increasingly numerous and diverse networked content and functionality, home entertainment devices should accommodate this increased choice capability with user interfaces that maintain the simplicity typically associated with conventional TVs and household appliances.

### SUMMARY OF THE INVENTION

A simple and consistent UI is provided across all types of content, regardless of how the content is stored and delivered. The UI enables all functions to be accessed using a small set of keys (or other commands such as voice or gesture), simplifying the user experience that can be ported to other devices. The UI is flexible and network-centric and its content and layout can be dynamically adjusted based on live content sent by the network. Users can own multiple different AVDDs each of which uses the same UI so users do not have to re-learn use. The UI also assists users in finding relevant content and functionality through relevant pushed content and recommendations which can appear within the mean menus of the UI, within content browsers, or in specific applications accessed through the UI.

According to principles set forth further below, an audio video display device (AVDD) has a processor, a video display presenting demanded images, and a computer readable storage medium bearing instructions executable by the processor. The processor presents on the display a graphical user interface (GUI) including Audio video display device (AVDD) comprising:

processor;

video display presenting demanded images;

computer readable storage medium bearing instructions executable by the processor to present on the display a first graphical user interface (GUI) including an L-shaped menu that is accessible from all content by actuating a menu key of a controller. As described below, the GUI includes a horizontal row of category icons arranged along one edge of the display. The GUI also includes a vertical column of content panes arranged along a vertical edge of the display. The row and column partially frame a remainder of the display in which live video from a current input source is presented. The content panes in the column represent content in a currently selected category represented by a currently selected icon.

In some embodiments content represented by the panes include live information, or promotions, or static icons used for launching other content. Responsive to a content pane being selected, content represented by the pane can be presented on the display. Also, if desired responsive to an icon being selected, the icon is moved to be directly beneath the column, and is enlarged relative to other icons, and an alpha-numeric name of a category represented by the icon is presented on screen below the icon.

In another aspect, an audio video display device (AVDD) has a processor, a video display presenting demanded images, and a computer readable storage medium bearing instructions executable by the processor to receive a “menu” selection is received from a remote control (RC) and responsive to the menu selection, present an L-shaped graphical user interface (GUI) on the display, shrinking current video to fit within a portion of the display not occupied by the GUI.

In another aspect, a remote control (RC) wirelessly communicating user commands to an audio video display device (AVDD) has a power on key that can be toggled to energize and deenergize the AVDD and a four way directional pad with up, down, left, and right directional arrows against which a user can move his finger to correspondingly move a screen cursor up, down, left, and right on the AVDD. The RC also includes a select key to select whatever item a screen cursor is positioned over. A menu key is provided to cause a graphical user interface (GUI) to be presented on the AVDD, and a volume up/down rocker key is on the RC to alter volume output of the AVDD. No other keys are on the RC.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a plan view of an example remote control (RC) that may be used to control the graphical user interfaces (GUI) described herein, schematically showing the processor and wireless transceiver;

FIG. 3 is a screen shot of a home menu GUI;

FIG. 4 is a flow chart of example logic; and

FIG. 5 is a screen shot of a banner bar GUI.

### DETAILED DESCRIPTION OF THE PREFERRED EMBODIMENT

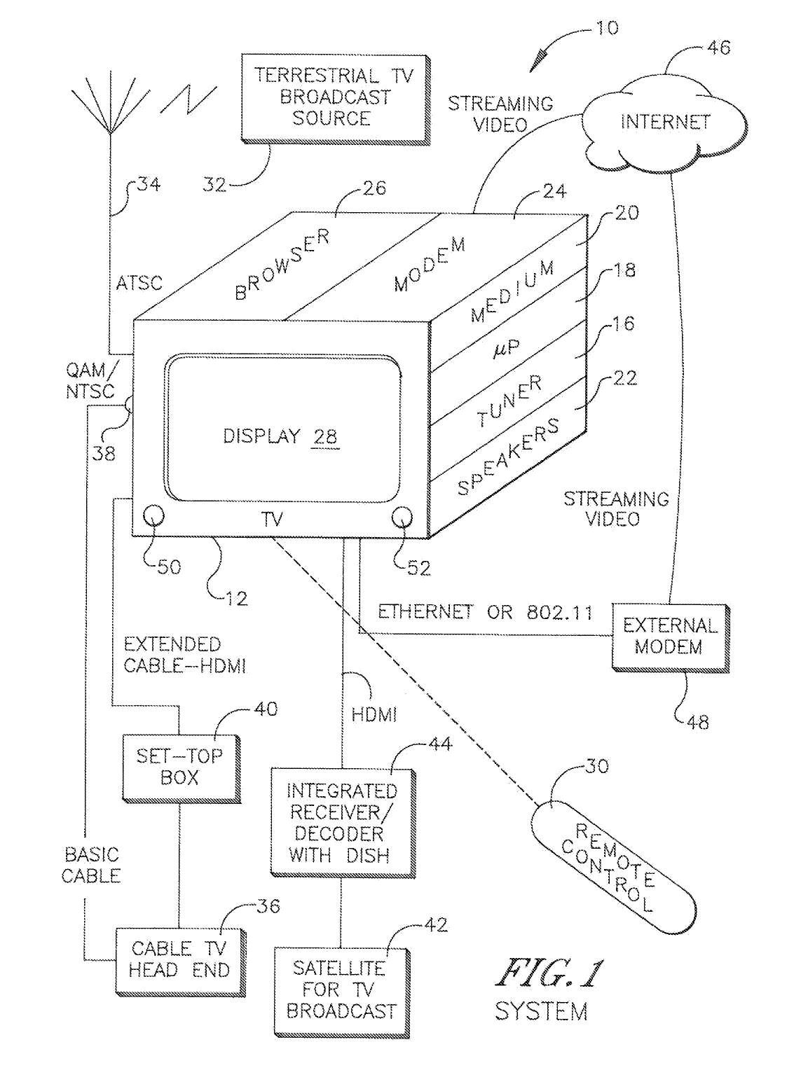

Referring initially to the non-limiting example embodiment shown in FIG. 1, a system 10 includes an audio video display device (AVDD) 12 such as a TV including a TV tuner 16 communicating with a TV processor 18 accessing a tangible computer readable storage medium 20 such as disk-based or solid state storage. The AVDD 12 can output audio on one or more speakers 22. The AVDD 12 can receive streaming video from the Internet using a built-in wired or wireless modem 24 communicating with the processor 18 which may execute a software-implemented browser 26. Video is presented under control of the TV processor 18 on a TV display 28 such as but not limited to a high definition TV (HDTV) flat panel display, and may be a touch screen display. User commands to the processor 18 may be wirelessly received from a remote control (RC) 30 using, e.g., rf or infrared. Audio-video display devices other than a TV may be used, e.g., smart phones, game consoles, personal digital organizers, notebook computers and other types of computers, etc.

TV programming from one or more terrestrial TV broadcast sources 32 as received by a terrestrial broadcast antenna 34 which communicates with the AVDD 12 may be presented on the display 28 and speakers 22. The terrestrial broadcast programming may conform to digital ATSC standards and may carry within it a terrestrial broadcast EPG, although the terrestrial broadcast EPG may be received from alternate sources, e.g., the Internet via Ethernet, or cable communication link, or satellite communication link.

TV programming from a cable TV head end 36 may also be received at the TV for presentation of TV signals on the display 28 and speakers 22. When basic cable only is desired, the cable from the wall typically carries TV signals in QAM or NTSC format and is plugged directly into the “F-type connector” 38 on the TV chassis in the U.S., although the connector used for this purpose in other countries may vary. In contrast, when the user has an extended cable subscription for instance, the signals from the head end 36 are typically sent through a STB 40 which may be separate from or integrated within the TV chassis but in any case which sends HDMI baseband signals to the TV. Other types of connections may be used, e.g., MOCA, USB, 1394 protocols, DLNA.

Similarly, HDMI baseband signals transmitted from a satellite source 42 of TV broadcast signals received by an integrated receiver/decoder (IRD) 44 associated with a home satellite dish may be input to the AVDD 12 for presentation on the display 28 and speakers 22. Also, streaming video may be received from the Internet 46 for presentation on the display 28 and speakers 22. The streaming video may be received at the computer modem 24 or it may be received at an in-home modem 48 that is external to the AVDD 12 and conveyed to the AVDD 12 over a wired or wireless Ethernet link and received at an RJ45 or 802.11x antenna on the TV chassis.

Also, in some embodiments a video camera 50, which may be integrated in the chassis if desired or mounted separately and electrically connected thereto, may be connected to the processor 18 to provide to the processor 18 video images of viewers looking at the display 28. Furthermore, a microphone 52 may be provided on the chassis or separate therefrom and can be electrically connected to the processor 18 to provide viewer-generated voice commands to the processor 18.

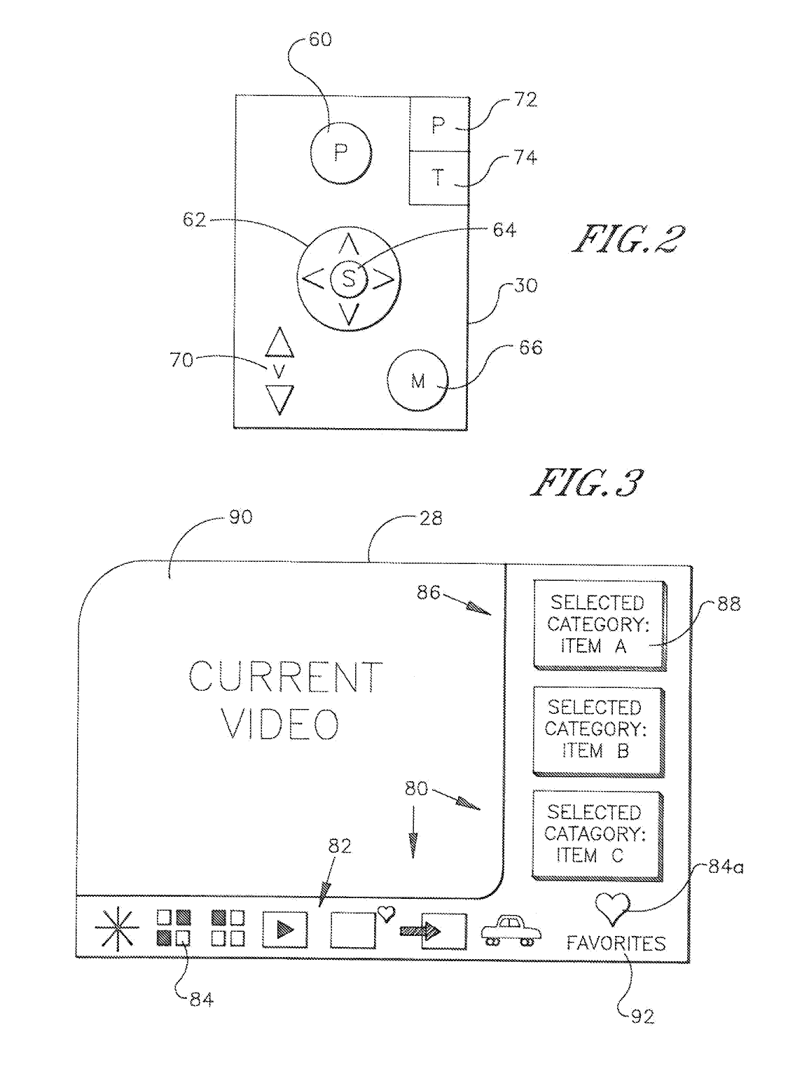

FIG. 2 shows that an example RC 30 may include a power on key 60 that can be toggled to energize and deenergize the AVDD 12. A four way directional pad 62 with up, down, left, and right directional arrows may be provided against which a user can move his finger to correspondingly move a screen cursor up, down, left, and right on the display 28. The four way directional pad may be replaced by a touch sensitive pad that a user can move his finger against to likewise moves a screen cursor on the display.

Also, a select key 64 may be provided to select whatever item the screen cursor happens to be positioned over. A menu key 66 may be provided to cause the below-described “home” GUI to be presented on the display 28, volume output by the speakers 22 of the AVDD 12 can be controlled using a volume up/down rocker key 70. Manipulation of a key or the pad 62 on the RC 30 causes a respective signal to be sent to an RC processor 72 in the RC 30, which transmits the corresponding command to the AVDD 12 using a wireless transceiver 74 such as but not limited to an infrared transceiver. Other keys may be provided but in the example shown, only the keys above are provided for simplicity of user experience.

It may now be appreciated that with a bare minimum keys, complexity of the RC is pared down. However, additional keys may be added as redundant shortcuts to frequently-used functionality, such as color keys or playback controls, but those functions should still be accessible via the basic minimal set of keys and onscreen UI elements. Certain functions may require more key presses than a single direct access shortcut, but the interaction becomes more screen-oriented and less “hunt-and-peck” on a typical remote control densely packed with specialized keys. By minimizing direct access keys required, the UI is increasingly portable to other rich input methods such as touch, gesture, voice.

FIG. 3 shows an example home GUI 80 that may be presented on the display 28 of the AVDD 12. As shown, the home GUI 80 includes an L-shaped menu that is accessible from all content by, e.g., actuating the menu key 66 of the RC 30. In the example shown, a horizontal row 82 of category icons 84 is arranged along one edge (in this case, the bottom edge) of the display 28, while at one end of the row 82 (in this case, the right end), a vertical column 86 of content panes 88 is arranged along a vertical edge of the display 28. The row 82 and column 86 partially frame the remainder 90 of the display 28 in which live video from the current input source is presented.

In the embodiment shown, the content panes 88 in the column 86 represent content in a currently selected category represented by a currently selected icon 84a. The content represented by the panes 88 may include, e.g., live information, promotions, as well as static icons used for launching other content. When a content pane 84 is selected, content represented by the pane such as video content is presented in the portion 90 of the display. Thus, a viewer can select the desired content category by appropriately selecting one of the icons 84, and content panes 88 related to the selected category then appear in the column 86. When a category icon is selected as the icon 84a (in the example shown, a heart-shaped icon representing favorite videos), the icon 84a is moved to be directly beneath the column 86. Also, in the example shown the selected icon 84a is enlarged relative to the other icons 84, and the alpha-numeric name 92 of the category of the currently selected icon 84a is presented on screen below the icon 84a. In contrast, icons 84 that are not currently selected appear but the names of the non-selected icons do not in the example shown.

Without limitations, the categories represented by the icons 84 may include “favorites”, “recommended” (i.e., content recommended by a recommendation engine using content recommendation principles based on user demographics and/or user activity with respect to the TV), satellite-sourced content, computer application content, cable-sourced content, disk player-sourced content, etc.

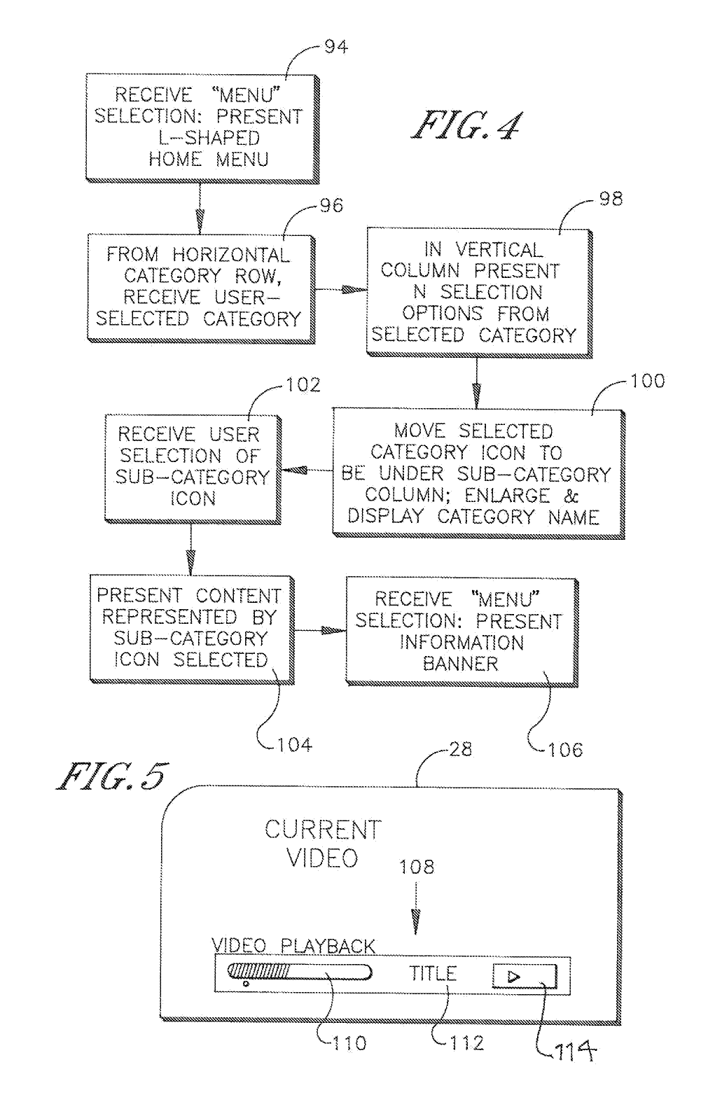

FIG. 4 is a flow chart of example logic illustrating use of the GUI shown in FIG. 3. In one example, the logic is executed by the AVDD processor 18. Commencing at block 94, a “menu” selection is received from the RC 30 responsive to a person actuating the menu key 66. This causes the L-shaped GUI 80 shown in FIG. 3 to be presented on the display 28, shrinking the current video to fit within the portion 90 of the display 28. Note that the currently selected icon 84a at the time the menu command is received may be the icon that was selected when the GUI 80 was last caused to be removed from the display subsequent to a previous toggle of the menu key 66.

Proceeding to block 96, a person may select a desired icon 84 using the point and click capability of the RC 30, and this is received, causing the logic to move to block 98 to present the “N” panes 88 shown (in this case, N=3) which represent content related to the category of the selected icon. At block 100, substantially simultaneously with icon selection the selected icon is moved beneath the column of panes and is enlarged, with its category name presented beneath as shown in FIG. 3. When a user selection of one of the panes 88 is received at block 102, the logic moves to block 104 to presented on the display 28 content represented by the selected pane 88. Block 106 indicates that a subsequent reception of a “menu” signal from the RC 30 can cause the GUI of FIG. 3 to be removed from display and the GUI of FIG. 5 discussed below to be presented on the display.

Accordingly and now turning to FIG. 5, a horizontally elongated universal information banner 108 is shown which may be made to appear near the bottom of the display 28 in accordance with description above regardless of the source (i.e., across all sources) of content being presented on the display 28. The banner 108 includes a fill bar 110 which indicates, by virtue of how much of its length is filled in, the playback status of the current video. Also, the banner 108 may include content metadata 112, and may provide playback control keys 114 such as a “play” selector element if applicable to the currently viewed content. Integrated into the banner are contextual options related to playback. These options are easily accessed using only the directional arrow keys 62 on the RC 30, and the status of each setting can be quickly understood in a glance. Note that the GUIs described herein may be presented by TVs, disk players, and other AVDDs.

It may now be appreciated that the above GUIs gracefully handle the display of promotions and partnerships, which can be revenue sources, and add value to the customer by providing targeted, relevant recommendations to bring their attention to content they may not otherwise have discovered. Featured partners can be visible (by means of e.g., content panes 88) directly within the GUI without drilling down to additional screens, and can be dynamically updated by an Internet server on a regular basis (e.g. weekly for IPTV services).

Additionally, promotional ads can appear in panes 88 related to any of the icon 84 categories, or can be clustered within a specific category (e.g., “Recommendations.”) The recommendations can come from any desired recommendation engine. In one implementation a client-based engine such as the so-called “Voyager” engine is used to provide broadcast recommendations based on a person's usage patterns of the current device. In addition, the manufacturer of the AVDD can push content to users and showcase new or related products by means of the panes 88.

Note further that the design of the column 86 of panes 88 is flexible and can accommodate different layouts. The information in the panes 88 can be sent as text, images, and are displayed directly in the panes. A server can send as text or graphic images, resulting in an engaging presentation that invites users to explore further content.

Additionally, the GUI 80 can be easily ported to a touch-screen interface. Additional interaction such as drag and dropping of onscreen elements—which take advantage of the unique capabilities of a touch-based interface, can be added—while still maintaining the overall structure of “main items” organized in a row along the bottom of the screen, and a “side bar” of items that are associated with a selected icon. The touch version can allow many convenient shortcuts available only through touch, which can enrich and enhance the overall user experience. For example, in the touch version a user can directly manipulate the GUI elements onscreen to launch or reorganize elements, or to directly interact with the decimated content window 90, by touching the display 28, which in this case is a touch screen display. The touch version can also include a system for displaying notifications onscreen, and simple touch shortcuts are available for full screen content, such as ‘double-finger swipe horizontally’ to change full screen content, and ‘double-finger swipe down’ to view notifications.

Recognizing that a TV is rarely a standalone device connected only to a content source, but is most often also connected to another device (such as external tuner, media playback device like BD/DVD/CD, game device, or PC, which may have its own user interface), the GUIs shown herein can be presented on such other devices as well to provide a common user experience across all devices. In such as case, i.e., when both a TV and another device can present the GUIs, the two devices can integrate the user interface to a single larger UI with expanded capability, rather than two separate UIs.

High definition multimedia interface-consumer electronics control (HDMI-CEC) can be supplemented with other networking technology such as digital living network alliance (DLNA) to allow connected devices to share information, for instance, to populate the GUIs shown herein. In an example scenario in which a disk player is connected to a TV, to avoid having the disk player's GUI displayed in the decimated video of the TV's GUI, the TV can send a command to the disk player to suppress its GUI. Thus, the present GUI is “modular” in the sense that when a specific device is connected to another, the combined functionality of the two devices increases, and so the UI should adapt accordingly to accommodate the increased functionality while maintaining a single user experience.

The above GUI provides a simple, intuitive framework that allows for future expansion in the era of networked home entertainment. By treating all different types of content with a consistent set of visual and interaction rules, the GUI reduces user interface complexity and provides users with a unified, enjoyable way to access content. By providing a UI that can display content both embedded in the device, as well as from the network, the UI can continue to grow with the device as features and services are added. The GUI thus provides a simple, intuitive framework that allows for future expansion in the era of networked home entertainment.

While the particular USER INTERFACE FOR AUDIO VIDEO DISPLAY DEVICE SUCH AS TV is herein shown and described in detail, it is to be understood that the subject matter which is encompassed by the present invention is limited only by the claims.

What is claimed is:

1. Audio video display device (AVDD) comprising:
processor;
video display presenting demanded images;
computer readable storage medium bearing instructions executable by the processor to:
present on the display a first graphical user interface (GUI) including an L-shaped menu that is accessible from all content by actuating a menu key of a controller, the GUI including a horizontal row of category icons arranged along one edge of the display, a vertical column of content panes being arranged along a vertical edge of the display, the row and column partially framing a remainder of the display in which live video from a current input source is presented, the content panes in the column representing content in a currently selected category represented by a currently selected icon.

2. The AVDD of claim 1, wherein content represented by the panes include live information.

3. The AVDD of claim 1, wherein content represented by the panes include promotions.

4. The AVDD of claim 1, wherein content represented by the panes include static icons used for launching other content.

5. The AVDD of claim 1, wherein responsive to a content pane being selected, content represented by the pane is presented on the display.

6. The AVDD of claim 1, wherein responsive to an icon being selected, the icon is moved to be directly beneath the column.

7. The AVDD of claim 1, wherein responsive to an icon being selected, the icon is moved to be directly beneath the column, and is enlarged relative to other icons.

8. The AVDD of claim 1, wherein responsive to an icon being selected, the icon is moved to be directly beneath the column, and is enlarged relative to other icons, and an alpha-numeric name of a category represented by the icon is presented on screen below the icon.

9. Audio video display device (AVDD) comprising:
processor;
video display presenting demanded images;
computer readable storage medium bearing instructions executable by the processor to:
receive a “menu” selection is received from a remote control (RC); and
responsive to the menu selection, present an L-shaped graphical user interface (GUI) on the display, shrinking current video to fit within a portion of the display not occupied by the GUI.

10. The AVDD of claim 9, wherein the processor, responsive to selection of a category icon from the GUI in a horizontal row of icons, presents “N” content panes in a column along a right side of the row of icons, the panes representing content related to a category of a selected icon.

11. The AVDD of claim 10, wherein substantially simultaneously with icon selection the selected icon is moved beneath the column of panes and is enlarged, with its category name presented beneath it.

12. The AVDD of claim 11, wherein the processor responsive to selection of one of the panes presents on the display content represented by the selected pane.

13. The AVDD of claim 12, wherein responsive to a subsequent reception of a “menu” signal, a horizontally elongated universal information banner is made to appear near a bottom of the display.

14. Remote control (RC) wirelessly communicating user commands to an audio video display device (AVDD), comprising:
a power on key that can be toggled to energize and deenergize the AVDD;
a four way directional pad with up, down, left, and right directional arrows against which a user can move his finger to correspondingly move a screen cursor up, down, left, and right on the AVDD;
a select key to select whatever item a screen cursor is positioned over;
a menu key to cause a graphical user interface (GUI) to be presented on the AVDD;
a volume up/down rocker key to alter volume output of the AVDD; and no other keys.

15. The RC of claim 14, wherein the AVDD has a display and the GUI is an L-shaped menu that is accessible from all content by actuating the menu key, the GUI including a horizontal row of category icons arranged along one edge of the display, a vertical column of content panes being arranged along a vertical edge of the display, the row and column partially framing a remainder of the display in which live video from a current input source is presented, the content panes in the column representing content in a currently selected category represented by a currently selected icon.

16. The RC of claim 15, wherein content represented by the panes include live information.

17. The RC of claim 15, wherein content represented by the panes include promotions.

18. The RC of claim 15, wherein content represented by the panes include static icons used for launching other content.

19. The RC of claim 15, wherein responsive to an icon being selected, the icon is moved to be directly beneath the column, and is enlarged relative to other icons, and an alpha-numeric name of a category represented by the icon is presented on screen below the icon.
